(19) United States
(12) Patent Application Publication
(10) Pub. No.: US 2008/0074412 A1
(43) Pub. Date: Mar. 27, 2008

(54) LIGHT EMITTING DEVICE, METHOD OF DRIVING PIXEL CIRCUIT, AND DRIVING CIRCUIT

(75) Inventor: Toshiyuki NOZAWA, Okaya (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/765,206

(22) Filed: Jun. 19, 2007

(30) Foreign Application Priority Data
Jul. 3, 2006 (JP) 2006-183054

(51) Int. Cl. G06F 3/038

(52) U.S. Cl. 345/212

(57) ABSTRACT

A method of driving a pixel circuit is provided. The pixel circuit includes a light emitting element that emits light by receiving a deriving current, a driving transistor that generates the driving current, and a light-emission control transistor of the same conductivity type as that of the driving transistor, the light-emission control transistor being arranged on a path through which the driving current flows from the driving transistor to the light emitting element. The method includes setting the gate potential of the light-emission control transistor so that the light-emission control transistor is turned on in the saturation region for a light emitting period during which the light emitting element is allowed to emit light.

### BACKGROUND

1. Technical Field

The present invention relates to a technique of controlling a light emitting element, such as an organic light emitting diode.

2. Related Art

Light emitting devices using active elements, such as thin film transistors, for controlling a current (hereinafter, referred to as a driving current) supplied to a light emitting element have been proposed. FIG. 18 shows the arrangement of a driving transistor T_{DR} and a light-emission control transistor T_{EL} on a path through which a driving current I_{DR} flows, the arrangement being disclosed in, for example, U.S. Pat. No. 6,229,506 and JP-A-2003-20049. The driving transistor T_{DR} generates the driving current I_{DR} according to the gate potential. The light-emission control transistor T_{EL}, arranged between the driving transistor T_{DR} and a light emitting element E, switches to the ON state for a predetermined period (hereinafter, referred to as a light emitting period), thus permitting supply of the driving current I_{DR} into the light emitting element E.

Although the operating points of most of the driving transistors T_{DR} are set so as to lie within a saturation region, the driving current I_{DR} is changed in accordance with the drain-source voltage of the corresponding driving transistor T_{DR} by the channel length modulation effect. On the other hand, the electrical characteristics of each light emitting element E include errors (e.g., an error from a design value and a variation between elements). For example, the relationship between the driving current I_{DR} and the voltage across the light emitting element E may differ from element to element. The difference in voltage across the light emitting element E between the elements leads to a fluctuation in drain-source voltage between the driving transistors T_{DR}. Unfortunately, even when the gate potentials of the respective driving transistors T_{DR} are set to the same value, the driving current I_{DR} supplied to each light emitting element E (therefore, the light intensity thereof) differs from element to element in accordance with its electrical characteristics.

### SUMMARY

An advantage of some aspects of the invention is to reduce the influence of the electrical characteristics of a light emitting element on a driving current.

According to an aspect of this invention, there is provided a method of driving a pixel circuit including a light emitting element that emits light by receiving a driving current, a driving transistor that generates the driving current, and a light-emission control transistor of the same conductivity type as that of the driving transistor, the light-emission control transistor being arranged on a path through which the driving current flows from the driving transistor to the light emitting element. The method includes setting the gate potential of the light-emission control transistor so that the light-emission control transistor is turned on in the saturation region for a light emitting period during which the light emitting element is allowed to emit light.

In accordance with this aspect of the invention, since the light-emission control transistor operates in the saturation region for the light emitting period, even when the potential of the node between the light-emission control transistor and the light emitting element changes in accordance with the electrical characteristics of the light emitting element, a change of the potential of the node between the light-emission control transistor and the driving transistor (the drain potential of the driving transistor) is suppressed. Therefore, the influence of the electrical characteristics of the light emitting element on the driving current can be reduced.

In an embodiment (e.g., a first embodiment which will be described below), preferably, the driving transistor and the light-emission control transistor are of P-channel type, the driving transistor is arranged between a first power supply line (e.g., a power supply line L₁ in FIG. 3) and the light-emission control transistor, the light emitting element is arranged between the light-emission control transistor and a second power supply line (e.g., a power supply line L₂ in FIG. 3). In this case, when let −V_{EL} (−V_{EL}<0) be the potential of the second power supply line with reference to the potential of the first power supply line, let V_{EL}_{_{—MAX (V}}_{EL}_{_{—}}_{MAX}<0) be the voltage across the light emitting element with a maximum voltage drop with reference to the potential of the electrode thereof on the light-emission control transistor side, let V_{T2} (V_{T2}<0) be the threshold voltage of the light-emission control transistor, and let V_{G}_{_{—}}_{On} be the gate potential of the light-emission control transistor, the gate potential of the light-emission control transistor for the light emitting period is set so as to satisfy the following relation: V_{G}_{_{—}}_{ON}>−V_{EL}−V_{EL}_{_{—}}_{MAX}+V_{T2}. In this case, the light-emission control transistor can be reliably allowed to operate in the saturation region.

Preferably, when let V_{DATA}_{_{—}}_{MAX} (V_{DATA}_{_{—}}_{MAX}<0) be the gate-source source voltage of the driving transistor of which the driving current reaches its maximum value and let V_{T1} (Vₜ₁<0) be the threshold voltage of the driving transistor, the gate potential of the light-emission control transistor for the light emitting period is set so as to satisfy the following relation: V_{G}_{_{—}}_{ON}<V_{DATA}_{_{—}}_{MAX}−V_{T1}+V_{T2}. In this case, since the driving transistor operates in the saturation region, the driving transistor can be used as a stable constant current source.

In another embodiment (e.g., a second embodiment which will be described below), the driving transistor and the light-emission control transistor may be of N-channel type, the light emitting element may be arranged between a first power supply line (e.g., a power supply line L₁ in FIG. 8) and the light-emission control transistor, the driving transistor may be arranged between the light-emission control transistor and a second power supply line (e.g., a power supply line L₂ in FIG. 8). Preferably, when let V_{EL} (V_{EL}>0) be the potential of the second power supply with reference to the potential of the second power supply line, let V_{EL}_{_{—}}_{MAX} (V_{EL}_{_{—}}_{MAX}>0) be the voltage across the light emitting element with a maximum voltage drop with reference to the potential of the electrode thereof on the light-emission control transistor side, let V_{T2} V_{T2}>0) be the threshold voltage of the light-emission control transistor, and let V_{G}_{_{—}}_{ON} be the gate potential of the light-emission control transistor, the gate potential of the light-emission control transistor for the light emitting period is set so as to satisfy the following relation: V_{G}_{_{—}}_{ON}<V_{EL}−V_{EL}_{_{—}}_{MAX}+V_{T2}. In this case, the light-emission control transistor can be reliably Allowed to operate in the saturation region.

Preferably, when let V_{DATA}_{_{—}}_{MAX} (V_{DATA}_{_{—}}_{MAX}>0) be the gate-source voltage of the driving transistor of which the driving current reaches its maximum value and let V_{T1} (V_{T1}>0) be the threshold voltage of the driving transistor, the gate potential of the light-emission control transistor for the light emitting period is set so as to satisfy the following relation: V_{G}_{_{—}}_{ON}>V_{DATA}_{_{—}}_{MAX}−V_{T1}+V_{T2}. Since the driving transistor operates in the saturation region, therefore, the driving transistor can be used as a stable constant current source.

In another embodiment (e.g., a fourth embodiment which will be described below), preferably, the pixel circuit includes a writing control translator (e.g., a transistor SW₁ shown in FIG. 12) arranged on a path extending from a node (e.g., a node N₁ shown in FIG. 12) between the driving transistor and the light-emission control transistor. The light-emission control transistor and the writing control transistor have the same conductivity type and size. The same potential as that at which the light-emission control transistor is turned on for the light emitting period is supplied to the gate of the writing control translator for a writing period precedent to the light emitting period to turn on the writing control transistor. The gate potential of the driving transistor is set by a current (e.g., a current I_{DATA} in FIG. 12) flowing through the driving transistor, the node, and the writing control transistor when the writing control transistor is turned on. In this case, since the potential supplied to the gate of the writing control transistor for the writing period is the same as that supplied to the gate of the light-emission control transistor for the light emitting period, the potential at the node between the driving transistor and the light-emission control transistor for the writing period substantially coincides with that for the light emitting period. Therefore, the amount of current flowing through the driving transistor for the writing period can be made coincide with that for the light emitting period with high accuracy.

According to another aspect of the invention, there is provided a driving circuit for driving a pixel circuit including a light emitting element that emits light by receiving a driving current, a driving transistor that generates the driving current, and a light-emission control transistor of the same conductivity type as that of the driving transistor, the light-emission control transistor being arranged on a path through which the driving current flows from the driving transistor to the light emitting element. The driving circuit includes a light-emission control circuit that sets the gate potential of the light emission control transistor so that the light-emission control transistor is turned on in the saturation region for a light emitting period during which the light emitting element is allowed to emit light. In this case, since the light-emission control transistor operates in the saturation region for the light emitting period, the influence of the electrical characteristics of the light emitting element on the driving current can be reduced.

According to another aspect of the invention, a light emitting device includes a pixel circuit and a light-emission control circuit. The pixel circuit includes a light emitting element that emits light by receiving a driving current, a driving transistor that generates the driving current, and a light-emission control transistor of the same conductivity type as that of the driving transistor, the light-emission control transistor being arranged on a path through which the driving current flows from the driving transistor to the light emitting element. The light-emission control circuit sets the gate potential of the light-emission control transistor so that the light-emission control transistor is turned on in the saturation region for a light emitting period during which the light emitting element is allowed to emit light. In this case, since the light-emission control transistor operates in the saturation regions for the light emitting period, the influence of the electrical characteristics of the light emitting device on the driving current can be reduced

Preferably, the pixel circuit includes a writing control transistor, a writing control circuit, and a data supply circuit. The writing control transistor is arranged between a data line and a node located between the driving transistor and the light-emission control transistor. The writing control circuit turns on the writing control transistor for a writing period precedent to the light emitting period. The data supply circuit supplies a current to the data line for the writing period to set the gate potential of the driving transistor. The light-emission control transistor and the writing control transistor have the same conductivity type and size. The potential supplied from the writing control circuit to the gate of the writing control transistor for the writing period is equivalent to that supplied from the light-emission control circuit to the gate of the light-emission control transistor for the light emitting period. In this case, since the gate potential of the writing control transistor for the writing period is the same as that of the light-emission control transistor for the light emitting period, the amount of current flowing through the driving transistor for the writing period can be made coincide with that for the light emitting period with high accuracy.

The light emitting device of the invention may be used in various electronic apparatuses. Typical examples of the electronic apparatuses include apparatuses (e.g., a personal computer and a mobile phone) each including the light emitting device as a display. Applications of the light emitting device of the invention are not limited to apparatuses for image display. The light emitting device of the invention can be used in various applications, such as an exposure apparatus (exposure head) for irradiating an image carrier, e.g., a photosensitive drum with a light beam to form a latent image on the image carrier and various illuminating apparatuses including an apparatus (backlight), arranged on the rear of a liquid crystal display, for illuminating the display, and an apparatus, mounted on an image reader, e.g., a scanner, for illuminating a document sheet.

### BRIEF DESCRIPTION OF THE DRAWINGS

The invention will be described with reference to the accompanying drawings, wherein like numbers reference like elements.

FIG. 1 is a block diagram of the structure of a light emitting device according to a first embodiment of the invention.

FIG. 2 is a timing chart showing the waveforms of selection signals and light=emission control signals.

FIG. 3 is a circuit diagram of the structure of a pixel circuit according to the first embodiment.

FIG. 4 is a conceptual diagram explaining the range of an ON potential V_{G}_{_{—}}_{ON}.

FIG. 5 is a graph showing curves each representing the relationship between current and voltage across a light emitting element.

FIGS. 6A and 6B are graphs showing curves each representing the relationship between a potential V_{DATA} and a driving current I_{DR}.

FIGS. 7A and 7B are graphs showing curves each representing the relationship between the potential V_{DATA} and the potential at a node.

FIG. 8 is a circuit diagram of the structure of a pixel circuit according to a second embodiment of the invention.

FIG. 9 is a conceptual diagram explaining the range of an ON potential V_{G}_{ON}.

FIG. 10 is a circuit diagram of the structure of a pixel circuit according to a third embodiment of the invention.

FIG. 11 is a timing chart explaining the operation of the pixel circuit shown in FIG. 10.

FIG. 12 is a circuit diagram of the structure of a pixel circuit according to a fourth embodiment of the invention.

FIG. 13 is a block diagram of the structure of a light emitting device according to the fourth embodiment.

FIG. 14 is a timing chart showing the waveforms of a selection signal and a light-emission control signal.

FIG. 15 is a perspective view of an electronic apparatus (personal computer) to which the invention is applied.

FIG. 16 is a perspective view of another electronic apparatus (mobile phone) to which the invention is applied.

FIG. 17 is a perspective view of another electronic apparatus (personal digital assistant) to which the invention is applied.

FIG. 18 is a circuit diagram of an arrangement for driving a light emitting element.

### DESCRIPTION OF EXEMPLARY EMBODIMENTS

### First Embodiment

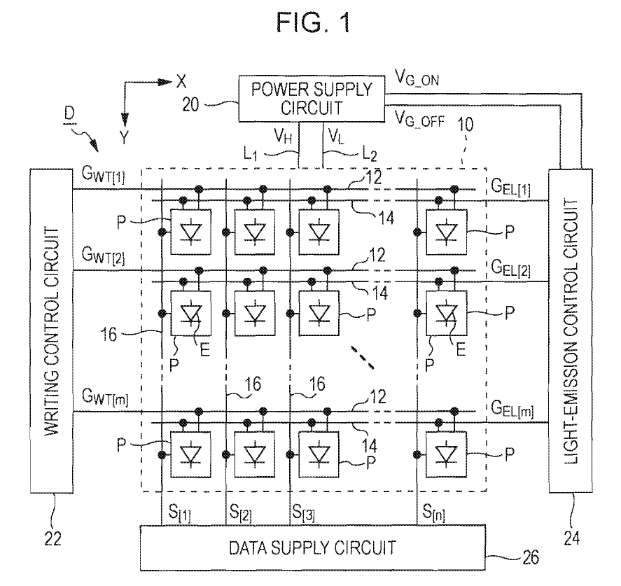

FIG. 1 is a block diagram of a light emitting device for use as an image display unit in various electronic apparatuses. A light emitting device D according to a first embodiment of the invention includes an element array 10 and peripheral circuits (i.e., a power supply circuit 20, a writing control circuit 22, a light-emission control circuit 24, and a data supply circuit 26). The element array 10 includes many pixel circuits P. The peripheral circuits control the pixel circuits P. Each pixel circuit P includes a light emitting element E which emits light by receiving a current.

In the element array 10, m selection lines 12 extending in the X direction, m light-emission control lines 14 extending in the X direction, and n data lines 16 extending in the Y direction that is perpendicular to the X direction (each of m and n is a natural number of two or more). Each light-emission control line 14 pairs with the corresponding selection line 12. Each pixel circuit P is arranged in the vicinities of the points of intersection of the selection line 12, the light-emission control line 14, and the data line 16. Therefore, these pixel circuits P are arranged in the X and Y directions in a matrix of m rows×n columns.

The power supply circuit 20 serves as a unit that generates a voltage for use in the light emitting device D. The power supply circuit 20 generates a high power supply potential V_{H} and a low power supply potential V_{L}. The high power supply potential V_{H} serves as a reference potential (0V) for the voltages across respective components and is supplied to the element array 10 via a power supply line L₁. The low power supply potential V_{L} is lower than the high power supply potential V_{H} by a voltage V_{EL} and is supplied to the element array 10 via a power supply line L₂. The power supply circuit 20 also generates an ON potential V_{G}_{_{—}}_{ON} and an OFF potential V_{G}_{_{—}}_{OFF} for use in the light-emission control circuit 24. In the present embodiment, the ON potential V_{G}_{_{—}}_{ON} is lower than the OFF potential V_{G}_{_{—}}_{OFF}. The ON potential V_{G}_{_{—}}_{ON} and the OFF potential V_{G}_{_{—}}_{OFF will be described in detail later.}

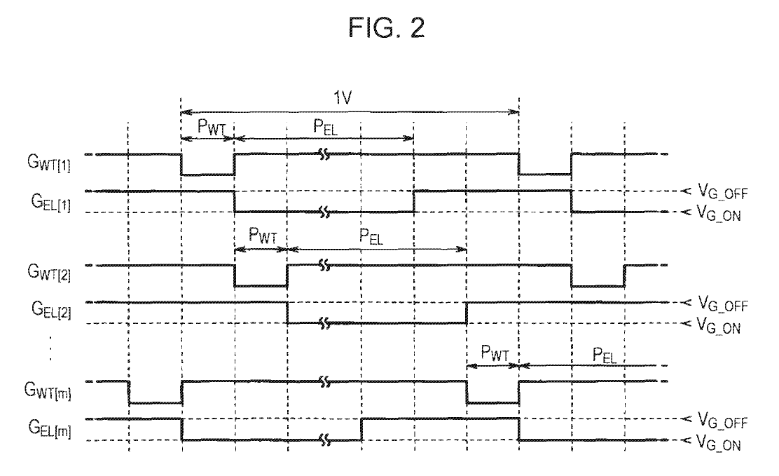

The writing control circuit 22 serves as a unit (e.g., an m-bit shift register) that generates selection signals G_{WT(1)} to G_{WT(m)} for sequential selection of the m selection lines 12 and outputs the signals to the respective selection lines 12. Referring to FIG. 2, the selection signal G_{WT(i)} supplied to the ith (i is a natural number satisfying 1≦i≦m) selection line 12 goes to a low level (selected) for an ith writing period (horizontal scanning period) P_{WT} of one frame period (1V) and is held at a high level (unselected) for a period other than the writing period in one frame.

Again referring to FIG. 1, the light-emission control circuit 24 serves as a unit (e.g., an m-bit shift register) that generates light-emission control signals G_{EL(1)} to G_{EL(m)} for specifying a period (hereinafter, referred to as a light emitting period) during which the light emitting element E actually emits light and outputs the signals to the respective light-emission control lines 14. Referring to FIG. 2, the light-emission control signals G_{EL(i)}, supplied to the ith light-emission control line 14, becomes the ON potential V_{G}_{ON} for a light emitting period P_{EL} corresponding to a predetermined time length after the writing period P_{WT}, during which the selection signal G_{WT(i)} becomes the low level. The light-emission control signal G_{EL(i)} is held at the OFF potential V_{G}_{_{—}}_{OFF} for a period other than the light emitting period P_{EL} in one frame.

Referring to FIG. 1, the data supply circuit 26 serves as a unit (e.g., n voltage-output D/A converters) for generating data signals S₍₁₎ to S₍ₙ₎ to specify a gray scale level (light intensity) of the light emitting element E and outputs the signals to the respective data lines 16. As for the data signal S₍ⱼ₎ supplied to the jth data line 16 for the writing period P_{WT} during which the selection signal G_{WT(i)} becomes the low level, the data signal S₍ⱼ₎ is controlled at a potential V_{DATA} according to the specified gray scale level of the pixel circuit P at the intersection of the ith row and the jth column.

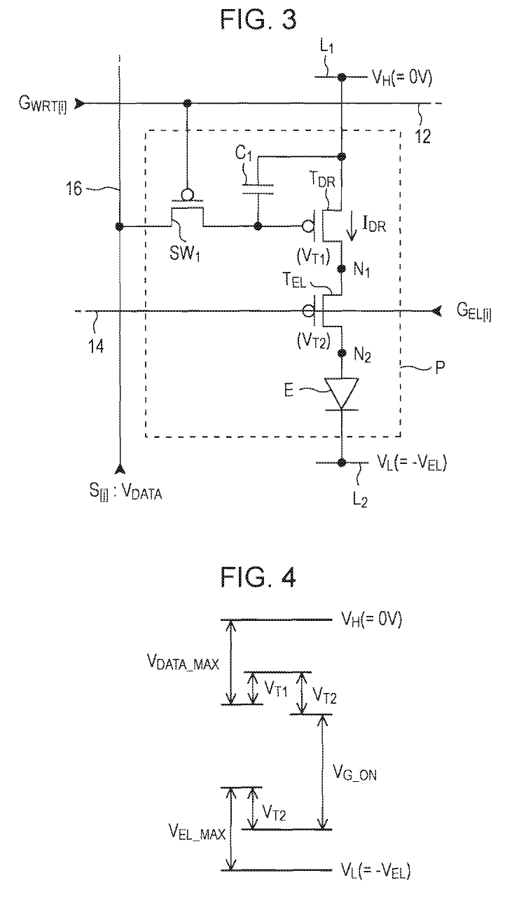

The specific structure of each pixel circuit P will now be described with reference to FIG. 3. FIG. 3 illustrates only one pixel circuit P at the intersection of the ith row and the jth column. The pixel circuits P constituting the element array 10 have the same structure. Referring to FIG. 3, the light emitting element E in the pixel circuit P is arranged on a path connecting to both of the power supply lines L₁ and L₂. The light emitting element E in accordance with this embodiment is an organic light emitting diode including an anode, a cathode, and a luminous layer arranged between the anode and the cathode. The luminous layer comprises an organic electroluminescent (EL) material. The light emitting element E emits light having an intensity (luminance) according to the amount of the driving current I_{DR} flowing between the anode and the cathode. The cathode of the light emitting element E is connected to the power supply line L₂.

A P-channel driving transistor T_{DR} is arranged on the path through which the driving current I_{DR} flows (between the powr supply line L₁ and the light emitting element E). The driving transistor T_{DR} serves as a unit that generates the driving current I_{DR} whose amount depends on the gate potential. The source of the driving transistor T_{DR} is connected to the power supply line L₁. A capacitor C₁ is arranged between the gate and the source (the power supply line L₁) of the driving transistor T_{DR}. A P-channel transistor SW₁ for controlling the electrical connection (conduction/non-conduction) between the gate of the driving transistor T_{DR} and the data line 16 is arranged therebetween. The gates of the transistors SW₁ belonging to the ith row are connected to the ith selection line 12.

A light-emission control transistor T_{EL} for controlling the electrical connection between the drain of the driving transistor T_{DR} and the anode of the light emitting element E is arranged therebetween (i.e., on the path of the driving current I_{DR} supplied from the driving transistor T_{DR} to the light emitting element E). The conductivity type of the light-emission control transistor T_{EL} is the P-channel type, the same as that of the driving transistor T_{DR}. The gates of the light-emission control transistors T_{EL} belonging to the ith row are connected to the ith light-emission control line 14. The ON potential V_{G}_{_{—}}_{ON} generated by the power supply circuit 20 is set to a level at which the light-emission control transistor T_{EL} is turned on when this potential is supplied to the gate thereof. The OFF potential V_{G}_{_{—}}_{OFF} is set to a level at which the light-emission control transistor T_{EL} is turned off when this potential is supplied to the gate thereof.

When the selection signal G_{WT(i)} goes to the low level during the writing period P_{WT}, the respective transistors SW₁ belonging to the ith row simultaneously switch to the ON state. In the pixel circuit P at the intersection of the ith row and the jth column, the potential V_{DATA} of the data signal S₍ⱼ₎ is supplied to the gate of the driving transitor T_{DR} and electric charges according on the potential V_{DATA} are stored in the capacitor C₁. The potential V_{DATA} is set in accordance with a desired light intensity specified for the light emitting element E so that the driving transistor T_{DR} operates in the saturation region when the light intensity of the light emitting element E reaches its maximum value. On the other hand, the light-emission control signal G_{EL(i)} goes to the OFF potential V_{G}_{_{—}}_{OFF} during the writing period P_{WT}. Accordingly, while the light-emission control Transistor T_{EL} is held at the OFF state, the driving current I_{DR} is interrupted, so that the light emitting element E is turned off.

After the writing period P_{WT}, the selection signal G_{WT(i)} goes to the high level, so that each transistor SW₁ switches to the OFF state. The gate of the driving transistor T_{DR} is held at the potential V_{DATA} by the capacitor C₁ during the light emitting period P_{EL} following the writing period P_{WT}. On the other hand, since the light-emission control signal G_{EL(i)} is set to the ON potential V_{G}_{_{—}}_{ON} during the light emitting period P_{EL}, the light-emission control transistor T_{EL} is turned on, thus establishing the path of the driving current I_{DR}. Therefore, the driving current I_{DR} according to the potential V_{DATA} at the gate of the driving transistor T_{DR} is supplied to the light emitting element E via the power supply line L₁, the driving transistor T_{DR}, and the light-emission control transistor T_{EL}. Consequently, the light emitting element E emits light with a light intensity depending on the potential V_{DATA}.

A current I_{D} flowing between the drain and the source of a transistor operating in the saturation region is expressed as the following Expression (1):

I_{D}=(β/2) (V_{GS-V}_{T})²(1+λ·V_{DS}) (1)

where β denotes the gain coefficient of the transistor, V_{T} denotes the threshold voltage thereof, V_{GS} indicates the gate-source voltage thereof, V_{DS} denotes the drain-source voltage thereof, and λ denotes a channel length modulation coefficient representing a change (gradient) in the current I_{D} when the voltage V_{DS} changes by a unit amount in the saturation region. As will be understood from Expression (1), although the driving transistor T_{DR} operates in the saturation region for the light emitting period P_{EL}, the driving current I_{DR} (corresponding to the current I_{D} in Expression (1)) depends on the drain-source voltage V_{DS} of the driving transistor T_{DR}, more specifically, the potential at a node N₁ between the driving transistor T_{DR} and the light-emission control transistor T_{EL}.

On the other hands, the electrical characteristics of each light emitting element E change due to various factors. such as an ambient temperature of the light emitting device D and elapsed time after formation of the light emitting element E. Furthermore, one light emitting device D has a variation in electrical characteristics between the light emitting elements E. Since the device D has a variation in characteristics between the light emitting elements E as described above, the potential at a node N₂ (the anode of the light emitting element E) between the light emitting element E and the light-emission control transistor T_{EL} changes in accordance with the characteristics of the light emitting element E. Assuming that the light-emission control transistor T_{EL} operates in a non-saturation region (linear region) for the light emitting period P_{EL}, the potential at the node N₁ (the voltage V_{DS} across the driving transistor T_{DR}) changes in accordance with the potential at the node N₂. As will be understood from Expression (1), therefore, the driving current I_{DR} changes in accordance with the characteristics of the light emitting element E. This leads to a variation in light intensity (gray scale level) between the respective light emitting elements E.

According to this embodiment, in order to solve the above-described disadvantages, the power supply circuit 20 generates the ON potential V_{G}_{_{—}}_{ON} so that each light-emission control transistor T_{EL} is turned on in the saturation region for the light emitting period P_{EL}. When the channel length modulation coefficient λ is sufficiently small in Expression (1), the current I_{D} flowing through the transistor is approximated by the following Expression (2)

Iₙ=(62/2) (V_{GS}−V_{T})². (2)

As will be understood from Expression (2), the current I_{D} flowing through the transistor operating in the saturation region is determined by the gate-source voltage V_{CS} and the threshold voltage V_{T}. In other words, when the current I_{D} is fixed, the gate-source voltage V_{GS} is also fixed to a predetermined value. Assuming that the light-emission control transistor T_{EL} operates in the saturation region, the gate-source voltage V_{GS} of the light-emission control transistor T_{EL} is determined in accordance with the driving current I_{DR} generated by the driving transistor T_{DR}. Therefore, the potential at the node N₁ is determined in accordance with the ON potential V_{G}_{_{—}}_{ON} supplied to the gate of the light-emission control transistor T_{EL} and is not affected by a change of the potential at the node N₂ caused by a variation in the characteristics of the light emitting element E. In Expression (2), the influence of the channel length modulation effect of the light-emission control transistor T_{EL} is ignored. If the channel length modulation effect is taken into consideration in a manner similar to Expression (1), since the channel length modulation coefficient λ is sufficiently small, the change of the potential at the node N₁ caused by the variation in the characteristics of the light emitting element E is sufficiently suppressed as compared to the case where the light-emission control transistor T_{EL} operates in the non-saturation region. As described above, according to this embodiment, setting the operating point of the light-emission control transistor T_{EL} within the saturation region suppresses the change of the potential at the node N₁. Advantageously, if there is a variation in the electrical characteristics of the light emitting element E, the driving current I_{dR} according to the potential V_{DATA} of the data signal S₍ⱼ₎ can be generated with high accuracy.

When the driving current I_{DR} approximates zero, the gate-source voltage V_{GS} of the light-emission control transistor T_{EL} sufficiently approximates the threshold voltage V_{T2} of the light-emission control transistor T_{EL}. In other words, the difference between the ON potential V_{G}_{_{—}}_{ON} supplied to the gate of the light-emission control transistor T_{EL} and the potential V_{N1} at the node N₁ (the source of the light-emission control transistor T_{EL}), therefore, the gate-source voltage V_{GS} of the light-emission control transist or T_{EL} approximates the threshold voltage V_{T2} (V_{G}_{_{—}}_{ON}−V_{N1}≈V_{T2}). Therefore, the potential V_{N1} at the node N₁ is held in the neighborhood of the difference between the ON potential V_{G}_{_{—}}_{ON} and the threshold voltage V_{T2} (V_{N1}≈V_{G}_{_{—}}_{ON}−V_{T2}). In other words, the characteristics of the light emitting element E are hardly affected by the potential V_{N1} at the node N₁.

Conditions of the ON potential V_{G}_{_{—}}_{ON} necessary for the operation of the light-emission control transistor T_{EL} in the saturation region will now be described. In order to allow the light-emission control transistor T_{EL} to operate in the saturation region, it is necessary that the drain-source voltage V_{DS} of the light-emission control transistor T_{EL} should be below the difference between the gate-source voltage V_{GS} and the threshold voltage V_{T2} (V_{T2}<0) (V_{DS}<V_{GS}−V_{T2}). When let V_{N2} be the potential at the node N₂, the above-described condition is expressed by the following Expression (a1):

V_{N2}<V_{G}_{_{—}}_{ON}−V_{T2}. (a1)

Let V_{EL}_{_{—}}_{MAX} be the voltage across the light emitting element E with a maximum voltage drop (i.e., when the voltage drop across the light emitting element E reaches its maximum value). The voltage V_{EL}_{_{—}}_{MAX} is determined with reference to a voltage applied to the anode in consideration of the range of variation in the characteristics of the light emitting element E and the driving current I_{DR} (V_{EL}_{_{—}}_{MAX}<0). In other words, the voltage V_{EL}_{_{—}}_{MAX} is the voltage across a light emitting element E when the maximum driving current I_{DR} is supplied (the highest gray scale level is designated) to the light emitting element across which the voltage reaches its maximum value because of errors of the electrical characteristics of the many light emitting elements E constituting the element array 10. Since the maximum value of the potential V_{N2} in Expression (a1) is expressed by (−V_{EL}−V_{EL}_{_{—}}_{MAX}), the range of the ON potential V_{G}_{_{—}}_{ON} for the operation of the light-emission control transistor T_{EL} in the saturation region is expressed by the following Expression (a2):

V_{G}_{_{—}}_{ON}>−V_{EL}−V_{EL}_{_{—}}_{MAX}+V_{T2}. (a2)

In this embodiment, the driving transistor T_{DR} operates in the saturation region for most of the range where the light intensity (gray scale level) of the light emitting element E changes. In order to allow the driving transistor T_{DR} to operate in the saturation region, it is necessary that the drain-source voltage V_{DR} of the transistor should be Below the difference between the gate-source voltage V_{GS} and the threshold volt age V_{T1} (V_{T1}<0) (V_{DS}<V_{GS}−V_{T1}). When let V_{DATA}_{_{—}}_{MAX} be the maximum value of the potential V_{DATA} of the data signal S₍ⱼ₎, the above-described condition is expressed By the following Expression (a3):

V_{N1}<V_{DATA}_{_{—}}_{MAX}−V_{T1}. (a3)

### The potential V_{DATA}_{_{—}}_{DATA}_{_{—}}_{MAX} is the potential at the gate of the driving transistor T_{DR} of which the driving current I_{DR} reaches its maximum value (i.e., the highest gray scale level is designated) (V_{DATA}_{_{—}}_{MAX}<0).

Further, in order to turn on the light-emission control transistor T_{EL} for the light emitting period P_{EL}, it is necessary that the gate-source voltage of the light-emission control transistor T_{EL} should be below the threshold voltage V_{T2}. In other words, the following Expression (a4) is satisfied:

V_{G}_{_{—}}_{ON}−V_{N1}<V_{T2}. (a4)

The following Expression (a5) is derived from the Expressions (a3) and (a4):

V_{G}_{_{—}}_{ON}<V_{DATA}_{_{—}}_{MAX}−V_{T1}+V_{T2}. (a5)

The ON potential V_{G}_{_{—}}_{ON} is selected from the range satisfying the following Expression (a6) as shown in FIG. 4 using Expressions (a2) and (a5):

V_{DATA}_{_{—}}_{MAX}−V_{T1}+V_{T2}>V_{G}_{_{—}}_{ON}>−V_{EL}−V_{EL}_{_{—MAX}}+V_{T2}. (a6)

As for the OFF potential V_{G}_{_{—}}_{OFF}, a voltage at which the light-emission control transistor T_{EL} is turned off may be used. For example, the high power supply potential V_{H} (0 V) is used as the OFF potential V_{G}_{_{—}}_{OFF.}

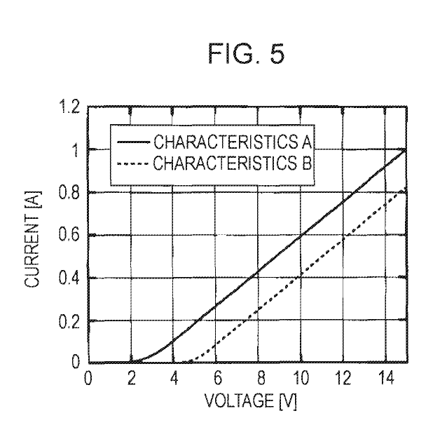

An advantage obtained in the case where the light-emission control transistor T_{EL} operates in the saturation region for the light emitting period P_{EL} will now be described while being compared to the case (hereinafter, referred to as a comparative example) where the light-emission control transistor T_{EL} operates in the non-saturation region. In the following description, it is assumed that the power supply potential V_{L} of the power supply line L₂ is set to −V_{EL} (=−18 V), the ON potential V_{G}_{_{—}}_{ON} in this embodiment is −9 V, and the ON potential V_{G}_{_{—}}_{ON} in the comparative example is −18 V. It is further assumed that a light emitting elements E has characteristics A and another light emitting element E has characteristics B as shown in FIG. 5. Referring to FIG. 5, when the driving current I_{DR} is set to the same value in both of the light emitting elements E, the voltage across the light emitting element E having the characteristics B is higher than that of the light emitting element E having the characteristics A.

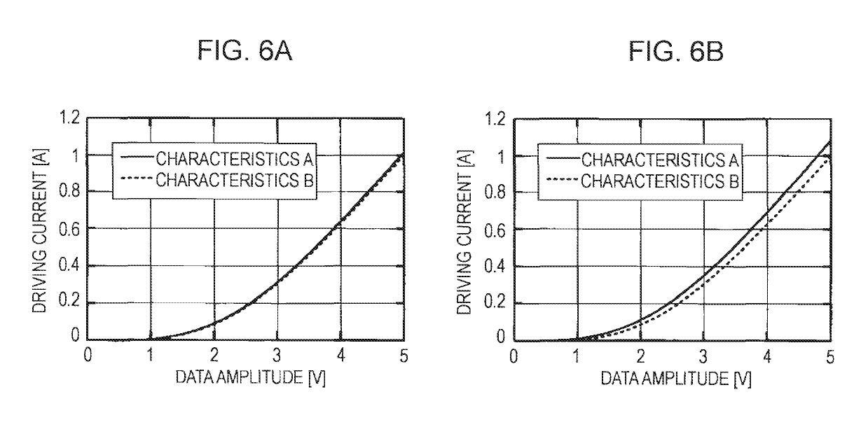

FIGS. 6A and 6B are graphs showing the relationship between the amplitude (absolute value) of the potential V_{DATA} and the driving current I_{DR} with respect to the characteristics A and B. FIG. 6A shows results in this embodiment. FIG. 6B shows results in the comparative example. In the comparative example, in the use of the same potential V_{DATA}, the driving currents I_{DR} differ from each other in accordance with the characteristics of the respective light emitting elements E. On the other hand, in this embodiment, in the use of the same potential V_{DATA}, the value of the driving current I_{DR} flowing to the light emitting element E having the characteristics A accurately coincides with that flowing to the other light emitting element E having the characteristics B.

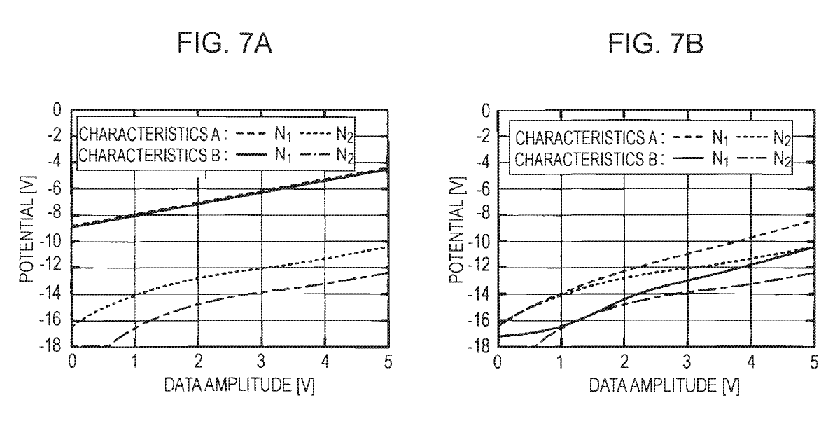

FIGS. 7A and 7B are graphs showing the relationship between the amplitude of the potential V_{DATA} and the potentials at the nodes (N₁ and N₂) with respect to the characteristics A and B. Similar to FIGS. 6A and 6B, FIG. 7A shows results in this embodiment and FIG. 7B shows results in the comparative example. Referring to FIG. 7B, when each light-emission control transistor T_{EL} operates in the non-saturation region, the potential at the node N₂ changes in accordance with the characteristics of the corresponding light emitting element E. Further, the potential at the node N₁ changes in association with the potential at the node N₂. On the other hand, referring to FIG. 7A, the potential at the node N₂ changes in accordance with the characteristics of each light emitting element E in this embodiment. However, since each light-emission control transistor T_{EL} operates in the saturation region, the potential at the node N₁ does not change in both of the light emitting element E having the characteristics A and that having the characteristics B.

As for an arrangement for maintaining the potential at the node N₁ at a predetermined value irrespective of the characteristics of the corresponding light emitting element E, for example, a transistor (hereinafter, referred to as a buffer transistor) different from the light-emission control transistor T_{EL} may be arranged between the light-emission control transistor T_{EL} and the driving transistor T_{DR}. During the light emitting period P_{EL}, the light-emission control transistor T_{EL} is allowed to operate in the non-saturation region in a manner similar to the comparative example and the buffer transistor is allowed to operate in the saturation region, thus reducing the influence of the characteristics of the light emitting element E on the potential at the node N₁. Unfortunately, the number of transistors constituting the pixel circuit P is increased by adding the buffer transistor. On the other hand, in this embodiment, one light-emission control transistor T_{EL} realizes a function of a switching element for controlling supply of the driving current I_{DR} to the corresponding light emitting element E and a function for reducing the influence of the electrical characteristics of the light emitting element E on the potential at the node N₁. Advantageously, the structure of the pixel circuit P can be simplified as compared to the arrangement with the buffer transistor,

### Second Emodiment

A second embodiment of the invention will now be described. Components having the same functions and operations as those of the components in the first embodiment are designated by the same reference numerals and a detail description thereof is omitted.

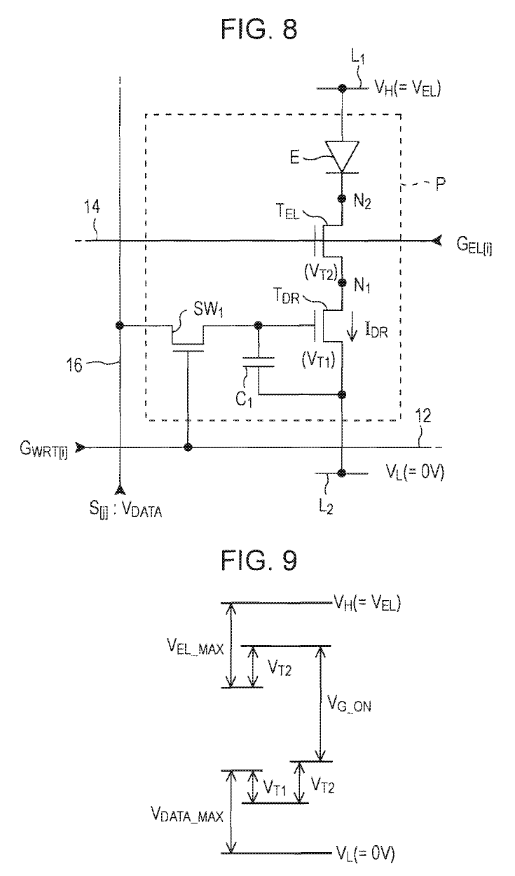

FIG. 8 is a circuit diagram of the structure of a pixel circuit P in the second embodiment. As shown in FIG. 8, transistors (e.g., a driving transistor T_{DR}, a light-emission control transistor T_{EL}, and a transistor SW₁) constituting the pixel circuit P are of N-channel type. Therefore, the relationship among power supply lines L₁ and L₂ and components of the pixel circuit P is the reverse of that in the first embodiment. In other words, the anode of a light emitting element E is connected to the power supply line L₁ and the source of the driving transistor T_{DR} is connected to the power supply line L₂. The potential V_{L} of the power supply line L₂ is a reference potential (0 V) for the voltages across respective components. The potential V_{H} of the power supply line L₁ is higher than the potential V_{L} by a voltage V_{EL} (V_{EL}>0). The light-emission control transistor T_{EL} is arranged between the cathode of the light emiting element E and the drain of the driving transistor T_{DR}. The position of the transistor SW₁ and that of a capacitor C₁ are the same as those in the first embodiment.

A light-emission control signal G_{EL(i)} becomes an ON potential V_{G}_{_{—}}_{ON} for a light emitting period P_{EL} and is held at an OFF potential V_{G}_{_{—}}_{OFF} for a period other than the light emitting period P_{EL} in a manner similar to the first embodiment. Since the light-emission control transistor T_{EL} is of N-channel type, the ON potential V_{G}_{_{—}}_{ON} is higher than the OFF potential V_{G}_{_{—}}_{OFF}. The ON potential V_{G}_{_{—}}_{ON} is determined so that the light-emission control transistor T_{EL} operates in the saturation region in a manner similar to the first embodiment. Conditions for the ON potential V_{G}_{_{—}}_{ON} will be described below.

Since it is necessary that the drain-source voltage V_{DS} of the light-emission control transistor T_{EL} should exceed the difference between the gate-source voltage V_{GS} and the threshold voltage V_{T2} (V_{T2}>0) of the transistor so that the transistor operates in the saturation region, the following Expression (b1) is satisfied:

V_{N2}>V_{G}_{_{—}}_{ON}−V_{T2}. (b1)

Since the maximum potential V_{N2} in expression (b1) is expressed as V_{EL}−V_{EL}_{_{—}}_{MAX}, the following Expression (b2) is derived from Expression (b1) (V_{EL}_{_{—}}_{MAX}>0):

V_{C}_{_{—}}_{ON}<V_{EL}−V_{EL}_{_{—}}_{MAX}+V_{T2}. (b2)

In addition, since it is necessary that the drain-source voltage V_{DS} of the driving transistor T_{dR} should exceed the difference between the gate-source voltage V_{GS} and the threshold voltage V_{T1} (V_{T1}>0) of the transistor in order to allow the driving transistor T_{DR} to operate in the saturation region, the following Expression (b3) is satisfied:

V_{N1}>V_{DATA}_{_{—}}_{MAX}−V_{T1}. (b3)

### A potential V_{DATA}_{_{—}}_{MAX (V}_{DATA}_{_{—}}_{MAX}>0) in Expression (b3) is the potential (maximum value of a potential V_{DATA}) at the gate of the driving transistor T_{DR} of which a driving current I_{DR} reaches its maximum value.

Further, since the light-emission control transistor T_{EL} switches to the ON state during the light emitting period P_{EL}, the following Expression (b4) is satisfied:

V_{G}_{_{—}}_{ON}−V_{N1}>V_{T2}. (b 4)

The following Expression (b5) is derived from Expressions (b3) and (b4):

V_{G}_{_{—}}_{ON}>V_{DATA}_{_{—}}MAX−V_{T1}+V_{T2}. (b5)

The ON potential V_{G}_{_{—}}_{ON} in this embodiment is selected from the range satisfying the following Expression (b6) using Expressions (b2) and (b5) as shown in FIG. 9:

V_{DATA}_{_{—}}_{MAX}−V_{T1}+V_{T2}<V_{C}_{_{—}}_{ON}<V_{EL}−V_{EL}_{_{—}}_{MAX}+V_{T2}. (b6)

As for the OFF potential V_{G}_{_{—}}_{OFF}, a potential at which the light-emission control transistor T_{EL} is turned off may be used. For example, the low power supply potential V_{L} (0 V) may be used as the OFF potential V_{G}_{_{—}}_{OFF}.

As described above, since the light-emission control transistor T_{EL} operates in the saturation region during the light emitting period P_{EL} in this embodiment, the influence of the electrical characteristics of each light emitting element E on the driving current I_{DR} flowing therethrough can be reduced.

### Third Embodiment

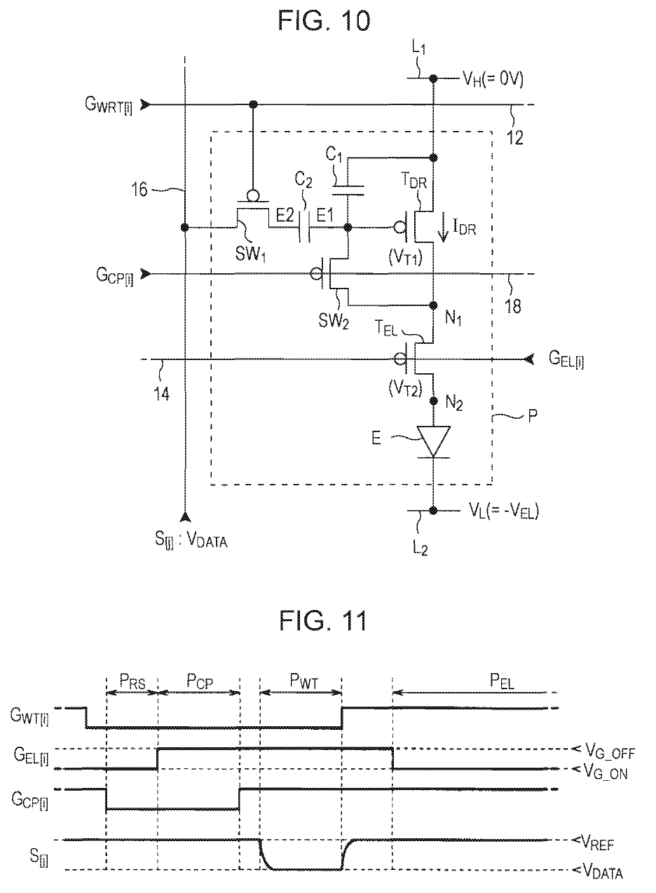

FIG. 10 is a circuit diagram of the structure of a pixel circuit P according to a third embodiment of the invention. Referring to FIG. 10, the pixel circuit P according to this embodiment includes a transistor SW₂ and a capacitor C₂ in addition to the same components as those in the first embodiment. The transistor SW₂ is a P-channel transistor, arranged between the gate and the drain of a driving transistor T_{DR}, for controlling the electrical connection between the gate and the drain. A control signal G_{CP(i)} is supplied from a driving circuit (not shown) to the gate of the transistor SW₂ via a control line 18. The capacitor C₂ includes an electrode E₁ and an electrode E₂. The electrode E₁ is connected to the gate of the driving translator T_{DR}. The transistor SW₂, arranged between the electrode E₂ and a data line 16, controls the electrical connection therebetween.

FIG. 11 is a timing chart showing the waveforms of signals supplied to the pixel circuit P at the intersection of the ith row and the jth column. Referring to FIG. 11, a resetting period P_{RS} and a compensating period P_{CP} are set just before a writing period P_{WT}. A selection signal G_{WT(i)} becomes a low level during the resetting period P_{RS}, the compensating period P_{CP}, and the writing period P_{WT} and becomes a high level for a light emitting period P_{EL}. A light-emission control signal G_{EL(i)} goes to an ON potential V_{G}_{_{—}}_{ON} for each of the resetting period P_{RS} and the light emitting period P_{EL} and goes to an OFF potential V_{G}_{_{—}}_{OFF} (V_{G}_{_{—}}_{OFF}>V_{G}_{_{—}}_{ON}) during the compensating period P_{CP} and the writing period P_{WT}. The control signal G_{CP(i)} becomes a low level during the resetting period P_{RS} and the compensating period P_{CP} and becomes a high level during the writing period P_{WT} and the light emitting period P_{EL}.

The operation of one pixel circuit P will now be described. Since the light-emission control signal G_{EL(i)} becomes the ON potential V_{G}_{_{—}}_{ON} during the resetting period P_{RS}, a light-emission control transistor T_{EL} is held in the ON state. Since the control signal G_{CP(i)} changes to the low level during this period, the gate of the driving transistor T_{DR} is connected to its drain via the transistor SW₂. During the resetting period P_{RS}, therefore, the gate (electrode E₁) of the driving transistor T_{DR} is initialized to a voltage according to the electrical characteristics of the light emitting element E. During the resetting period P_{RS} and the compensating period P_{CP}, while the transistor SW₂ is being held in the ON state in response to the selection signal G_{WT(i)}, a data signal S₍ⱼ₎ is held at a reference potential V_{REF}. Consequently, the electrode E₂ is held at the reference potential V_{REF}.

When the compensating period P_{CP} starts, the light-emission control signal G_{EL(i)} changes to the OFF potential V_{G}_{_{—}}_{OFF}, so that the light-emission control transistor T_{EL} is turned off. Therefore, the potential at the gate of the driving transistor T_{DR} (i.e., the electrode E₁ of the capacxitor C₂) converges on a level corresponding to the difference between the power supply potential V_{H} (0 V) of the power supply line L₁ and the threshold voltage V_{T1} of the driving transistor T_{DR} until the compensating period P_{CP} terminates.

During the writing period P_{WT}, the change of the control signal G_{CP(i)} to the high level causes the gate of the driving transistor T_{DR} to disconnect its drain and the data signal S₍ⱼ₎ changes from the reference potential V_{REF} to a potential V_{DATA} while the transistor SW₂ is being held in the ON state. Since the impedance at the gate of the driving transistor T_{DR} is sufficiently high, the potential at the electrode E₁ (i.e., the potential at the gate of the driving transistor T_{DR}) changes in accordance with a change of the potential at the electrode E₂ (i.e., a change of the difference between the reference potential V_{REF} and the potential V_{DATA}). In other words, the gate of the driving transistor T_{DR} is set to a potential depending on the potential V_{DATA}. During the light emitting period P_{EL} after the writing period P_{WT}, setting of the light-emission control signal G_{EL(i)} to the ON potential V_{G}_{_{—}}_{ON} causes the light-emission control transistor T_{EL} to turn on, so that a driving current I_{DR} depending on the potential at the gate of the driving transistor T_{DR} is supplied to the light emitting element E via the light-emission control transistor T_{EL}. Consequently, the light emitting element E emits light with an intensity depending on the potential V_{DATA}.

As described above, in this embodiment, the potential at the gate of the driving transistor T_{DR} is allowed to converge on a potential corresponding to the threshold voltage V_{T1} for the compensating period P_{CP} and is changed using the capacitor C₂ for the writing period P_{WT}, so that the gate of the driving transistor T_{DR} is set to a potential depending on the potential V_{DATA}. Therefore, an error in the threshold voltage V_{T1} of the driving transistor T_{DR} can be compensated for and the driving current I_{DR} depending on the potential V_{DATA} can be generated with high accuracy.

The ON potential V_{G}_{_{—}}_{ON} in this embodiment is selected from the range expressed by the following Expression (c) for allowing the light-emission control transistor T_{EL} and the driving transistor T_{DR} to operate in the saturation region in a manner similar to the first embodiment using Expression (a6). Therefore, the same advantages as those of the first embodiment are obtained in this embodiment.

V_{DATA}_{_{—}}_{MAX}−V_{T1}+V_{T2}>V_{G}_{_{—}}_{ON}>−V_{EL}−V_{EL}_{_{—}}_{MAX}+V_{T2} (c)

A potential V_{DATA}_{_{—}}_{MAX} in this embodiment is the potential at the gate of the driving transistor T_{DR} set during the writing period P_{WT} when the potential V_{DATA} is selected so that the driving current I_{DR} reaches its maximum value and is different from the potential V_{DATA} of the data line 16.

### Fourth Embodiment

A fourth embodiment of the invention will now be described. The foregoing embodiments have described the pixel circuits P of a voltage programming type in which the light intensity of each light emitting element E is set in accordance with the potential V_{DATA} of the data line 16. Pixel circuits P according to the fourth embodiment are of a current programming type in which the light intensity of each light emitting element E is set in accordance with a current I_{DATA} following through a data line 16.

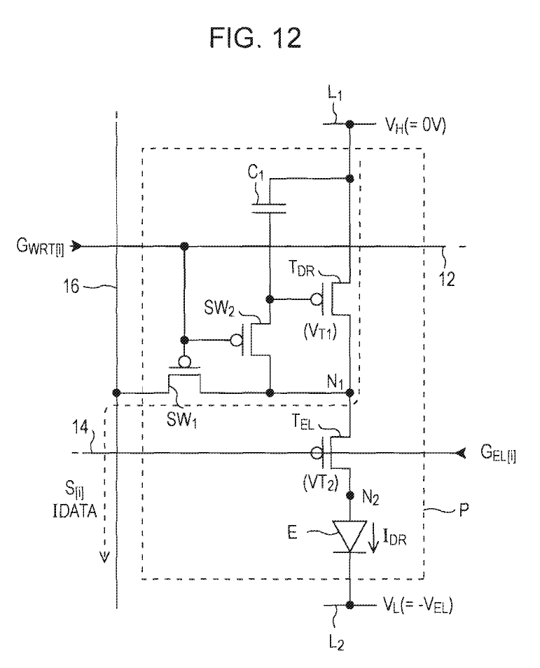

FIG. 12 is a circuit diagram showing the structure of a pixel circuit P. Referring to FIG. 12, the pixel circuit P according to this embodiment includes transistors SW₁ and SW₂ of P-channel type which is the same as that of a driving transistor T_{DR} and that of a light-emission control transistor T_{EL}. The transistor SW₁ is arranged on a path extending between the data line 16 and a node N₁, which is located between the driving transistor T_{DR} and the light-emission control transistor T_{EL}. The transistor SW₁ controls the electrical connection between the drain of the driving transistor T_{DR} and the data line 16. The transistor SW₁ and the light=emission control transistor T_{EL} are arranged close to each other and have the same size (channel length, channel width). The transistor SW₂ controls the electrical connection between the gate and the drain of the driving transistor T_{DR}. The gates of the respective transistors SW₁ and SW₂ are connected to a selection line 12.

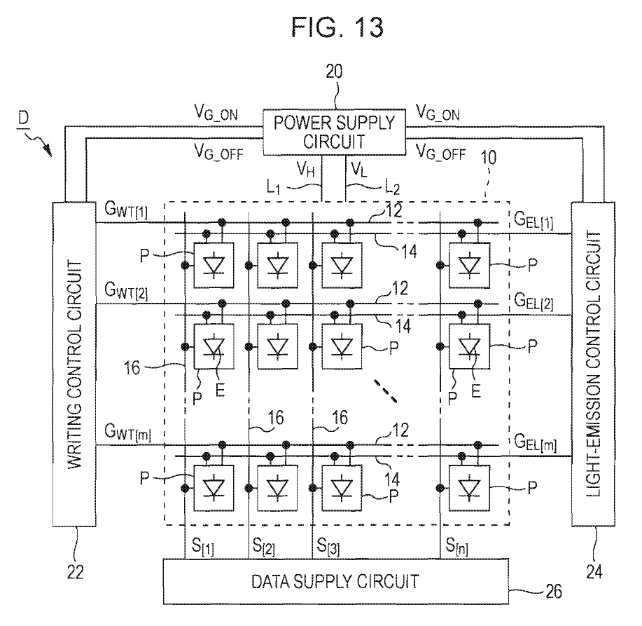

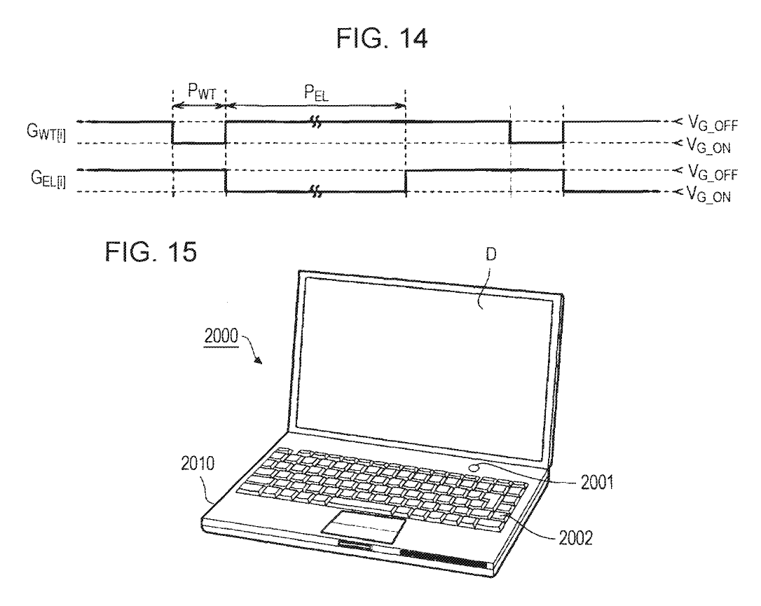

FIG. 13 is a block diagram of the structure of a light emitting device D according to this embodiment. Referring to FIG. 13, a power supply circuit 20 supplies an ON potential V_{G}_{_{—}}_{ON} and an OFF potential V_{G}_{_{—}}_{OFF} to each of a light-emission control circuit 24 and a writing control circuit 22 (V_{G}_{_{—}}_{ON}<V_{G}_{_{—}}_{OFF}). As shown in FIG. 14, the writing control circuit 22 sets a selection signal G_{WT(i)} to the ON potential V_{G}_{_{—}}_{ON} for a writing period P_{WT} and sets the selection signal to the OFF potential V_{G}_{_{—}}_{OFF} for a period (including a light emitting period P_{EL}) other than the writing period P_{WT}. The waveform of a light-emission control signal G_{EL(i)} is the same as that in the first embodiment.

A data supply circuit 26 serves as a unit (for example, n current-output D/A converters) for setting a data signal s₍ⱼ₎ to a current I_{DATA} depending on a gray scale level designated for a pixel circuit P at the intersection of the ith row and the jth column for the writing period P_{WT} during which the selection signal G_{WT(i)} becomes the ON potential V_{G}_{_{—}}_{ON}.

In the above-described arrangement, when the selection signal G_{WT(i)} changes to the ON potential V_{G}_{_{—}}_{ON} during the writing period P_{WT}, the gate of the driving transistor T_{DR} is connected to its drain via the transistor SW₂. In addition, the supply of the ON potential V_{G}_{_{—}}_{ON} causes the transistor SW₁ to turn on. Therefore, the current I_{DATA} of the data signal S₍ⱼ₎ flows from a power supply line L₁ into the jth data line 16 via the driving transistor T_{DR}, the node N₁, and the transistor SW₁ as shown by a broken line in FIG. 12. Consequently, a voltage depending on the current I_{DATA} is held in a capacitor C₁.

During the light emitting period P_{EL} aftr the writing period P_{WT}. The selection signal G_{WT(i)} is set to the OFF potential V_{G}_{_{—}}_{OFF}, so that the transistors SW₁ and SW₂ are turned off. When the light-emission control signal G_{EL(i)} changes to the ON potential V_{G}_{_{—}}_{ON} and the light-emission control transistor T_{EL} is turned on, a driving current I_{ON} according to the potential at the gate of the driving transistor T_{DR} (i.e., a potential held by the capacitor C₁ for the preceding writing period P_{WT}) is supplied to the light emitting element E via the light-emission control transistor T_{EL}. Consequently, the light emitting element E emits light with an intensity depending on the current I_{DATA}.

In this embodiment, the ON potential V_{G}_{_{—}}_{ON} is selected from the range expressed by the following Expression (d) in which the light-emission control transistor T_{EL} is allowed to operate in the saturation region in a manner similar to the first embodiment using Expression (a6). Therefore, the same advantages as those of the first embodiment are obtained in this embodiment.

V_{DATA}_{_{—}}_{MAX}−V_{T1}+V_{T2}>V_{G}_{_{—}}_{ON}>−V_{EL}−V_{EL}_{_{—}}_{MAX}+V_{T2} (d)

A potential V_{DATA}_{_{—}}_{MAX} in Expression (d) is the potential (V_{DATA}_{_{—}}_{MAX}<0) at the gate of the driving transistor T_{DR} set during the writing period P_{WT} when the current I_{DATA} is selected so that the driving current I_{DR} reaches its maximum value.

In this embodiment, the transistor SW₁ and the light-emission control transistor T_{EL} are arranged close to each other and have the same characteristics (i.e., the same conductivity type and the same size). Further, the transistor SW₁ and the light-emission control transistor T_{EL} are turned on according to the same ON potential V_{G}_{_{—}}_{ON}. With this arrangement, the potential at the node N₁ (potential at the drain of the driving transistor T_{DR}) for the writing period P_{WT} coincides with that for the light emitting period P_{EL}. Therefore, the amount of the current I_{DATA} for the writing period P_{WT} can be accurately made coincide with that of the driving current I_{DR} for the light emitting period P_{EL}. In other words, the light intensity of the light emitting element E can be controlled with high accuracy in accordance with the current I_{DATA}.

### Modifications

The above-described embodiments may be variously modified. Modifications will be described below. The following modifications may be appropriately used in combination

### First Modification

In each of the first to third embodiments, the ON potential V_{G}_{_{—}}_{ON} and the OFF potential V_{G}_{_{—}}_{OFF} generated by the power supply circuit 20 may be used as voltages for the selection signals G_{WT(1)} to G_{WT(m)} generated by the writing control circuit 22 in a manner similar to the fourth embodiment. With this arrangement, the number of voltages generated by the power supply circuit 20 is reduced, thus achieving a reduction in scale of the power supply circuit 20 and a reduction in power consumption.

### Second Modification

In each of the third and fourth embodiments, each pixel circuit P includes P-channel transistors. The conductivity type of transistors in FIGS. 10 and 12 may be appropriately changed to N-channel type in a manner similar to the second embodiment. Further, it is unnecessary that all of transistors constituting each pixel circuit P have the same conductivity type. In other words, so long as the driving transistor T_{DR} and the light-emission control transistor T_{EL} have the same conductivity type, the transistors SW₁ and SW₂ may have any conductivity type.

### Third Modification

With the arrangement in which the driving transistor T_{DR} operates in the saturation region in the same way as in the foregoing embodiments, the driving transistor T_{DR} can be allowed to serve as a constant current source for stably generating the driving current I_{DR}. Since the desired advantages of the invention are obtained so long as the light-emission control transistor T_{EL} operates in the saturation region, it is not always necessary to set the operating point of the driving transistor T_{DR} in the saturation region. For example, it is unnecessary to satisfy Expression (a5) in the first embodiment and Expression (b5) in the second embodiment.

### Fourth Modification

In each of the above-described embodiments, the organic light-emitting diode has been described as the light emitting element E. The invention can be applied to various light emitting devices using light emitting elements other than the organic light-emitting diodes. Various light emitting elements, such as a light emitting diode each including a luminous layer made of an inorganic electroluminescent material, a field emission (FE) element, a surface-conduction electron-emitter (SE), and a ballistic electron surface emitting (BS) element, may be used in the invention.

### Applications

Electronic apparatuses related to the invention will now be described. FIGS. 15 to 17 illustrate electronic apparatuses each including the above-described light emitting device D as a display unit.

FIG. 15 is a perspective view of a mobile personal computer including the light emitting device D. A personal computer 2000 includes the light emitting device D for image display and a main body 2010 provided with a power supply switch 2001 and a keyboard 2002. The light emitting device D enables clear image display with a wide viewing angle because the light emitting device D includes organic light-emitting diodes as the light emitting elements E.

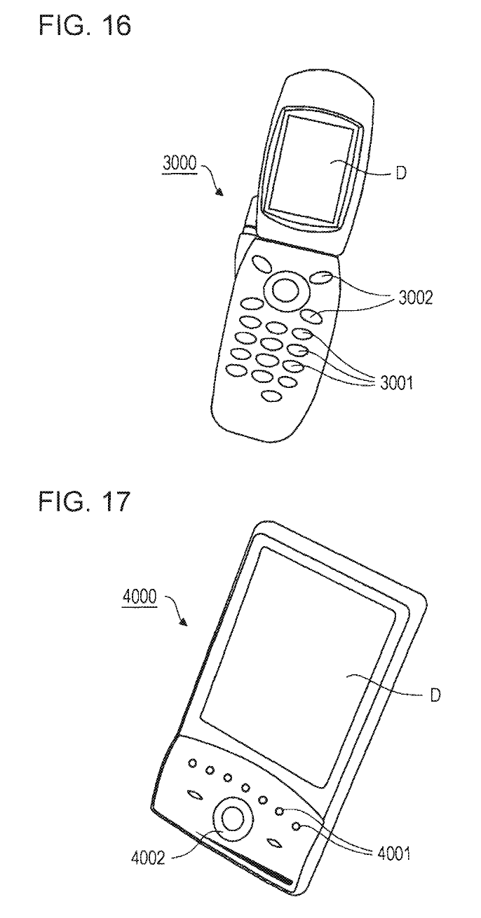

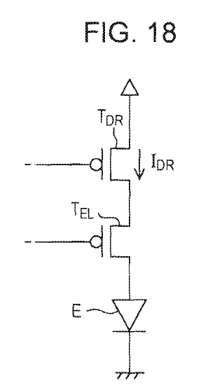

FIG. 16 is a perspective view of a mobile phone including the light emitting device D. A mobile phone includes a plurality of operation buttons 3001, scroll buttons 3002, and the light emitting device D for image display. Operating the scroll buttons 3002 scrolls images displayed on the light emitting device D.

FIG. 17 is a perspective view of a personal digital assistant (PDA) including the light emitting device D. A PDA 4000 includes a plurality of operation buttons 4001, a power supply switch 4002, and the light emitting device D for image display. Operating the power supply switch 4002 allows for display of various pieces of information, such as an address list and a schedule hook, on the light emitting device D.

Electronic apparatuses, each including the light emitting device of the invention, include a digital still camera, a television, a video camera, a car navigation system, a pager, an electronic organizer, an electronic paper, an electronic calculator, a word processor, a workstation, a video phone, a POS terminal, a printer, a scanner, a copy machine, a video player, and an apparatus having a touch panel in addition to the apparatuses shown in FIGS. 15 to 17. Applications of the light emitting device of the invention are not limited to apparatuses for image display. For example, an electrophotographic image forming apparatus uses an exposure unit (line head) for exposing a photosensitive member in accordance with an image to be formed on a recording member, such as a sheet of paper. The light emitting device of the invention may also be used as this type of exposure device.

The entire disclosure of Japanese Patent Application No. 2006-183054, filed Jul. 3, 2006 is expressly incorporated by reference herein.

What is claimed is:

1. A method of driving a pixel circuit including a light emitting element that emits light by receiving a driving current, a driving transistor that generates the driving current, and a light-emission control transistor of the same conductivity type as that of the driving transistor, the light-emission control transistor being arranged on a path through which the driving current flows from the driving transistor to the light emitting element, the method comprising:
setting the gage potential of the light-emission control transistor so that the light-emission control transistor is turned on in the saturation region for a light emitting period during which the light emitting element is allowed to emit light.

2. The method according to claim 1, wherein
the driving transistor and the light-emission control transistor are of P-channel type,
the driving transistor is arranged between a first power supply line and the light-emission control transistor,
the light emitting element is arranged between the light-emission control transistor and a second power supply line, and
when let −V_{EL} (−V_{EL}<0) be the potential of the second power supply line with reference to the potential of the first power supply line, let V_{EL}_{_{—}}_{MAX (V}_{EL}_{_{—}}_{MAX}0) be the voltage across the light emitting element with a maximum voltage drop with reference to the potential of the electrode thereof on the light-emission control transistor side, let V_{T2} (V_{T2}<0) be the threshold voltage of the light-emission control transistor, and let V_{G}_{_{—}}_{ON} be the gate potential of the light-emission control transistor, the gate potential of the light-emission control transistor for the light emitting period is set so as to satisfy the following relation: V_{G}_{_{—}}_{ON}>−V_{EL}−V_{EL}_{_{—}}_{MAX}+V_{T2}.

3. The method according to claim 2, wherein
when let V_{DATA}_{_{—}}_{MAX} (V_{DATA}_{_{—}}_{MAX}0) be the gate-source voltage of the driving transistor of which the driving current reaches its maximum value and let V_{T1} (V_{T1}<0) be the threshold voltage of the driving transistor, the gate potential of the light-emission control transistor for the light emitting period is set so as to satisfy the following relation: V_{G}_{_{—}}_{ON}<V_{DATA}_{_{—}}_{MAX}−V_{T1}+V_{T2}.

3. The method according to claim 2, wherein
when let V_{DATA}_{_{—}}_{MAX} (V_{DATA}_{_{—}}<0) be the gate-source voltage of the driving transistor of which the driving current reaches its maximum value and let V_{T1} (V_{T1}<0) be the threshold voltage of the driving transistor, the gate potential of the light-emission control transistor for the light emitting period is set so as to satisfy the following relation: V_{G}_{_{—}}_{ON}<V_{DATA}_{_{—}}_{MAX}−V_{T1}+V_{T2}.

4. The method according to claim 1, wherein
the driving transistor and the light-emission control transistor are of N-channel type,
the light emitting element is arranged between a first power supply line and the light-emission control transistor,
the driving transistor is arranged between the light-emission control transistor and a second power supply line, and
when let V_{EL} (V_{EL}>0) be the potential of the first power supply line with reference to the potential of the second power supply line, le t V_{EL}_{_{—}}_{MAX (V}_{EL}_{_{—}}_{MAX}>0) be the voltage across the light emitting element with a maximum voltage drop with reference to the potential of the electrode thereof on the light-emission control transistor side, let V_{T2} (V_{T2}>0) be the threshold voltage of the light-emission control transistor, and let V_{G}_{_{—}}_{ON} be the gate potential of the light-emission control transistor, the gate potential of the light-emission control transistor for the light emitting period is set so as to satisfy the following relation: V_{G}_{_{—}}_{ON}<V_{EL}−V_{EL}_{_{—}}_{MAX}+V_{T2}.

5. The method according to claim 4, wherein
when let V_{DATA}_{_{—}}_{MAX} (V_{DATA}_{_{—}}_{MAX}>0) be the gate-source voltage of the driving transistor of which the driving current reaches its maximum value and let V_{T1} (V_{T1}>0) be the threshold voltage of the driving transistor, the gate potential of t he light-emission control transistor for the light emitting period is set so as to satisfy the following relation: V_{G}_{_{—}}_{ON}>V_{DATA}_{_{—}}_{MAX}−V_{T1}+V_{T2}.

6. The method according to claim 1, wherein
the pixel circuit includes a writing control transistor arranged on a path extending from a node between the driving transistor and the light-emission control transistor,
the light-emission control transistor and the writing control transistor have the same conductivity type and the same size,
the same potential as that at which the light-emission control transistor is turned on for the light emitting period is supplied to the gate of the writing control transistor for a writing period precedent to the light emitting period to turn on the writing control transistor, and
the gate potential of the driving transistor is set by a current flowing through the driving transistor, the node, and the writing control transistor when the writing control transistor is turned on.

7. A driving circuit for driving a pixel circuit including a light emitting element that emits light by receiving a driving current, a driving transistor that generates the driving current, and a light-emission control transistor of the same conductivity type as that of the driving transistor, the light-emission control transistor being arranged on a path through which the driving current flows from the driving transistor to the light emitting element, the circuit comprising:
a light-emission control circuit that sets the gate potential of the light-emission control transistor so that the light-emission control transistor is turned on in the saturation region for a light emitting period during which the light emitting element is allowed to emit light.

8. A light emitting device comprising:
a pixel circuit including a light emitting element that emits light by receiving a driving current, a driving transistor that generates the driving current, and a light-emission control transistor of the same conductivity type as that of the driving transistor, the light-emission control transistor being arranged on a path through which the driving current flows from the driving transistor to the light emitting element; and
a light-emission control circuit that sets the gate potential of the light-emission control transistor so that the light-emission control transistor is turned on in the saturation region for a light emitting period during which the light emitting element is allowed to emit light.

9. The device according to claim 8, wherein
the pixel circuit includes:
a writing control transistor arranged between a data line and a node located between the driving transistor and the light-emission control transistor;
a writing control circuit that turns on the writing control transistor for a writing period precedent to the light emitting period; and
a data supply circuit for supplying a current to the data line for the writing period to set the gate potential of the driving transistor,
the light-emission control transistor and the writing control transistor have the same conductivity type and size,
a potential supplied from the writing control circuit to the gate of the writing control transistor for the writing period is equivalent to a potential supplied from the light-emission control circuit to the gate of the light-emission control transistor for the light emitting period.
